(19) United States
(12) Patent Application Publication
(10) Pub. No.: US 2009/0053118 A1
(43) Pub. Date: Feb. 26, 2009

(54) SYSTEM FOR REMOVING IMPURITIES FROM SOLIDS

(76) Inventor: CHANG H. LEE, Ghaziabad (IN)

Correspondence Address: William H. Honaker;Dickinson Wright PLLC, Ste 2000, 38525 Woodward Ave., Bloomfield Hills, MI, 48304-2970, US

(21) Appl. No.: 12/104,524

(22) Filed: Apr. 17, 2008

(30) Foreign Application Priority Data
Apr. 19, 2007 (IN) 856/DEL/2007

(51) Int. Cl. B07B 13/11

(52) U.S. Cl. 422/255

(57) ABSTRACT

The invention relates to an ion exchanger for removing impurities from solids comprising an inlet for receiving a solid solution containing impurities, and a flow modifier for modifying the flow of the solid solution within the ion exchanger.

The present invention relates to the removal of impurities from solids. More particularly, the invention relates to a method and system for the removal of impurities from solids using ion exchange.

### DESCRIPTION OF RELATED ART

Various materials and elements required in industry are in, or required in solid form and contain contaminants and impurities. Purification of solids to remove impurities is a complex and often expensive process, though is often essential in order to meet the standards required for their end use. Moreover, various industrial processes also require separation of mixtures and recovery of precious substances in catalysis of chemical reactions. Carbon is one such solid used in industry and the invention shall be explained with reference to the removal of impurities or purification of carbon, as an example.

Even if origin of the impurities is determined, removal or prevention of the same is not always practically possible. This is often on account of the cost of treatment that render the process not economically feasible, or sometimes due to lack of adequate treating technology. Though separation or classification to remove or reduce impurities in solids such as carbon has been done using air or dry systems, these methods often results in imperfections or inconsistency in the treated carbon.

Purification of carbon involves removal or separation of impurities that mostly come from raw materials such as feedstock, catalysts, additives, water; and process metallurgy such as rusts and scales. Impurities originate from diverse causes including raw materials and/or manufacturing conditions. The feedstock is a typical source of impurities, for example fluid catalytic cracker (FCC) oil used in the manufacture of furnace carbon black may contain catalysts used in the refinery which remain in carbon.

Carbon is generally characterized by the fact that its majority is elemental carbon, C12 which accounts for over 99.9 wt. %. However, sometimes the content of elemental carbon is much lower, which results in the deterioration of value of the final product. Moreover, it is often imperative to purify or increase the content of elemental carbon in order to meet the standards and requirements of an application. For example, physical strength such as modulus, tensile strength, and elongation; and functional properties such as dispersibility, color shade, darkness, undertone, chromaticity, electric and thermal conductivity, UV protection, EMI shielding, electrostatic charge dissipation, reinforcement, and catalysis; service life; and so forth are effected by a decrease in the content of elemental carbon and the presence of impurities.

Impurities in solids, such as carbon include for example H⁺, Li⁺, Na⁺, K⁺, NH4⁺, Rb⁺, Cs⁺, Ag⁺, Ti⁺, Ba²⁺, Ni²⁺, Fe³⁺, Ca²⁺, Mg²⁺, Zn²⁺, Co²⁺, Cu²⁺, Sr²⁺, Pb²⁺, Cd²⁺, OH—, I—, NO₃₋, HSO₄₋, HSO₃₋, BrO₃₋, CIO₃₋, HCO₃₋, HSiO₃₋, BI—, CN—, NO₂—, CL-, IO₃₋, F—, formate, benzene, sulphonate, salicylate, acetate, propionate, citrate, and phenate.

Ion exchangers or the principle of using ion exchange has been predominantly used in the water industry to purify or separate unwanted ions out of water for specific purposes, such as drinking, or for pharmaceutical, chemical, atomic and co-generation plant applications. In addition, ion exchange has also been used in other industries for varied purposes, for example, absorption of specific ions, acid purification, acid retardation, acid removal for corrosion control, sugar processing, beverage processing, catalysis of organic reactions, caustic purification, chromatographic separations, condensate polishing, demineralization, fine chemicals synthesis, formic acid removal from formaldehyde, inhibitor and stabilizer removal, ion retardation, metals control, mineral processing, mining, radium removal from ground water, salts removal, trace contaminant removal, and ultra-pure chemicals production.

The principle of ion exchange has so far not been applied for the removal of impurities or the purification of solids. Moreover, the principle of ion exchange has not been applied for the removal of impurities or purification of carbon.

### SUMMARY OF THE INVENTION

The invention provides for a method and system for removing impurities from solids using ion exchange.

The invention relates to a method of removing impurities from solids in which a solution with the solid is formed, the solution is passed through an ion exchanger such that at least some impurities present in the solution are retained by the ion exchanger, and the solution is recovered from the ion exchanger. The solution so recovered from the ion exchanger may be filtered and dried to obtain solids from which at least some impurities have been removed.

The invention also provides for a system for ion exchange containing ionic elements including functional ionic resin or resins; and furnished with accessories and parts that enables the solid solution to disperse homogeneously throughout the ionic elements or resins.

### BRIEF DESCRIPTION OF THE DRAWINGS

The accompanying drawing illustrates the preferred embodiments of the invention and together with the following detailed description serves to explain the principles of the invention.

FIG. 1 illustrates a system for removing impurities in solids in accordance with embodiments of the invention.

FIG. 2 illustrates a system for removing impurities in solids in accordance with another embodiment of the invention.

FIG. 3 illustrates a recovery system for resins used in the ion exchange system in accordance with an embodiment of the invention.

FIG. 4 illustrates a distributor in accordance with an embodiment of the invention.

### DETAILED DESCRIPTION OF PREFERRED EMBODIMENTS

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. The invention has been explained for a method of removing impurities from carbon, but as would be obvious to a person in the art, the invention may be applied to any solid.

The term ion exchanger and exchanger have been used inter-changeably and denote the same system for ion exchange.

The invention relates to the removal of impurities from solids and has been described for the removal of impurities from carbon as an example. In particular the invention describes a method and system for the removal of impurities from solids using ion exchange. The impurities are removed by first forming a solution of the solid. The solid solution is then passed through an ion exchange system where the impurities are retained. The solution enables a better contact of impurities present in solids with resins of an ion exchange system.

A solution as referred to herein includes any suspension, colloid, slurry formed by mixing the solid with a suitable liquid medium. The solution may be formed with or without the aid of chemicals.

The invention is applicable to all solids. In the present example, the invention is applicable to any carbon type, including carbons required in different industries, such as amorphous carbon black, by-product carbon, carbon fiber, carbon fibril, single wall nanotube (SWNT), multiple wall nanotube (MWNT), natural graphite, artificial graphite, graphitized amorphous carbon, activated carbon, artificial diamond, bone-black, pyro-black recovered from scrap tires, and fly-ash carbon. The different carbon types are manufactured by various processes, for example furnace process, channel process, gas process, thermal process, acetylene process, plasma process, and other petrochemical process.

A solid solution is formed by mixing the solid with any suitable liquid and preferably also includes a dispersion aid. A dispersion aid may be any one or a combination of an acid, base, alcohol, acetate, anionic surfactant or non-ionic surfactant. A non ionic or anionic surfactant is preferably used as a dispersion aid.

Preferably the liquid used for forming the solid solution is water. The water may be raw water or de-mineralized water, though it is preferable to use de-mineralized water. The ratio of solid in the solution is preferably in the range of 0.5 to 10 wt. %. It is however possible to work the invention at larger solid ratios. The solid solution is formed by adding the solid to a liquid along with the dispersing aid and mixing the same thoroughly to create a homogeneous solution. For example, 2 kg of carbon black, N330 as per ASTM D1765, is mixed with 40 gallons of water along with a non ionic surfactant and mixed using a high shearing impeller mixer for 30 minutes at 1800 rpm.

The solid solution so formed is capable of dispersing more completely in the ionic element bed of the ion exchanger and thus ensures a better removal of impurities. Forming of the solid solution also improves contact between the ionic elements in the ion exchanger such as resins and the impurities present in the solids.

A solid solution so formed is passed through a system of removing impurities from solids, such as an ion exchanger as described by the invention. To achieve a better mixing of the solid solution with the ionic elements of the ion exchanger as well as to avoid build up of solid residues along the sides of the ion exchanger and on the bead surface of ionic elements, it is desirable to create a tangential, helical, spiral or agitated flow of the solid solution within the ion exchanger. This tangential, helical or spiral flow of the solid solution within the ion exchanger may be created in various ways with or without the use of compressed air. A flow modifier is employed to create the modified flow of the solid solution within the ion exchanger.

The flow modifier could be side inlet means for the solid solution that causes the solid solution to enter the ion exchanger in a tangential manner. The flow modifier can also be an inlet for passing compressed air that causes the solid solution to bubble, scatter and mix with the resins of the ion exchanger. Alternatively, the flow modifier may be side inlet means for compressed air to enter the ion exchanger. The flow modifier can also be a distributor for the compressed air or the solid solution. The distributor has a profile cut on it that causes either the solid solution or the compressed air to flow in a tangential, helical, agitated or spiral manner. Preferably, the distributor is provided with a helical cut for the desired flow. The flow modifier may be any of the preceding either alone or in combination with the others. The flow modifier can also be any other suitable means that causes the solid solution to move in a tangential, helical, spiral or agitated manner.

For example, the tangential flow may be created by introducing the solid solution from the sides of the ion exchanger. Alternatively, the tangential helical, spiral or agitated flow may be created by introducing the solid solution from the sides of the ion exchanger and introducing compressed air from the bottom. The air so introduced will enter the ion exchanger through one or more distributors with a profile cut on it that creates a spiral flow.

In another embodiment, the compressed air is introduced from the sides of the ion exchanger and the solid solution is introduced from the bottom. The solid solution may enter the ion exchanger through one or more distributors with a profile cut, preferably helical, that in combination with the compressed air creates a spiral flow.

In another embodiment, both solid solution and compressed air are introduced from the bottom and enter the ion exchanger through one or more distributors with a profile cut, preferably helical, that creates a spiral flow.

Thus the flow of the solid solution may be modified by any of the above, or any other suitable means that results in a uniform mixing of the solid solution with the resin bed.

In accordance with an embodiment of the invention, it is preferable that the ion exchanger be vertically mounted and it is also preferable that the solid solution enters the ion exchanger from the bottom and exits from the top. This is to prevent blocking of voids in resin bed of ion exchanger.

The solid solution containing impurities enters the exchanger through an inlet and passes over the ionic elements where impurities present in the solution react with the ionic elements or resins and are held within the ionic element bed is recovered from the ion exchanger. In accordance with the preferred embodiment, the solid solution is recovered from the top end of the exchanger. On account of various parameters including level of dispersion of the solid in the solution and that of the solid solution within the exchanger, as also on the species and/or the density of the solid and the type of ionic element or resin beads, some ionic element or resin is also discharged from the ion exchanger along with solid solution. Under ideal operating conditions, it is desired that only the solid solution devoid of any ionic element or resin is discharged from the exchanger. To minimize the discharge of ionic elements or resins from the ion exchanger the solid solution is first preferably passed through a mesh before exiting the exchanger.

The discharge of ionic elements or resins from the ion exchanger may also be minimized by controlling the rate of flow of the solid solution through the exchanger. A faster rate of flow causes more resins to exit the exchanger.

In accordance with an embodiment of the invention, flow rate measurement means are provided at a point close to the discharge outlet of the ion exchanger. On the basis of flow rate determined, and past experience co-relating flow rate with discharge of resins, adjustments to the flow rate may be made. Alternatively, in accordance with another embodiment of the invention, pressure sensing means may be provided on the screen placed before the discharge port. It is desirable to keep the pressure on the screen to a minimum and preferably nil, pressure on screen indicating a high flow rate and consequently discharge of ionic elements or resins from exchanger.

Carbon, treated in accordance with the teachings of the invention has been found to have reduced amount of ash and extractable elements and can be shipped in the form of wet powder or dry beads after pelletizing. The carbon solution recovered may be treated by conventional methods of filtering and drying.

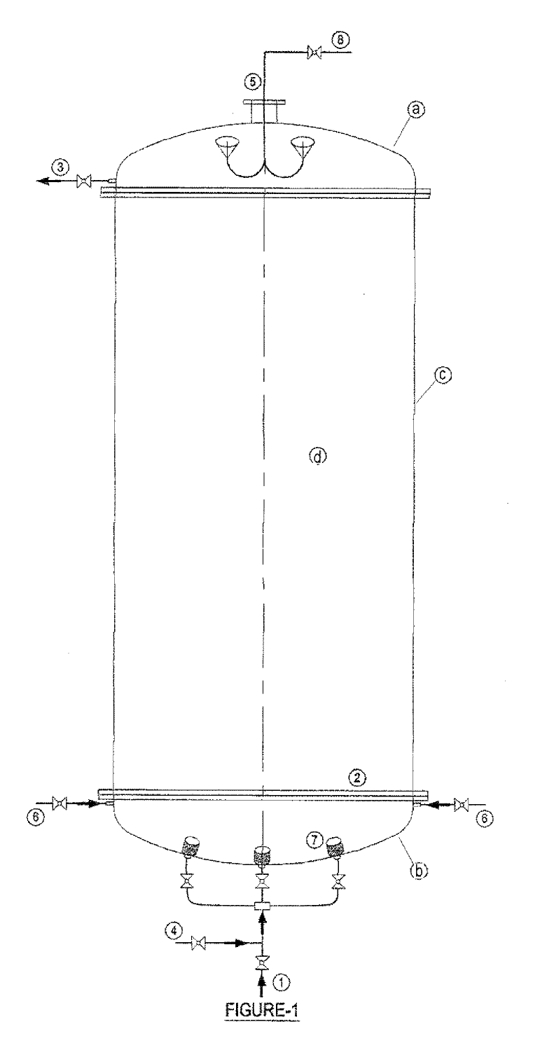

With reference to the accompanying drawings and initially to FIG. 1 an ion exchanger in accordance with an embodiment of the invention is illustrated. As illustrated the ion exchanger is preferably mounted vertically. The ion exchanger has a top dish plate (a) and a bottom dish plate (b), with a cylindrical body in between (c). The ionic element or resin bed (d) is typically placed between the top and bottom dish plates. A plurality of openings is provided in both the top and bottom dish plates.

Openings (1) and (4) in the bottom dish plate may be used for the inlet of solid solution, air or alternatively, may be used as an outlet for ion exchanger regenerator. The exchanger is also provided with at least one opening on the side (6), two in the example shown, that serve as flow modifiers. The opening (6) may be used for the inlet of air or solid solution. The provision of inlets (6) on the sides of the ion exchanger results in the solid solution or air to enter the ion exchanger in a tangential manner. It is preferred that the inlets are symmetrically distributed around the circumference of the exchanger and in the present example illustrated, are diametrically opposite each other.

It is preferred that the inlet for the solid solution and the compressed air be in the lower 10% height of the ion exchanger, and more preferably in the lower 5% height. Accordingly, it is preferred that the inlets for solid solution and compressed air be in the lower/bottom dish plate. Similarly, it is preferred that the discharge ports for the solid solution and the air be in the top 10% height of the ion exchanger, and more preferably in the top 5% height. Accordingly, it is preferred that the discharge ports for the solid solution and the air be in top dish plate. This is to ensure a greater length of travel of the solid solution within the ion exchanger, and consequently a better mixing of the solid solution with the resin bed.

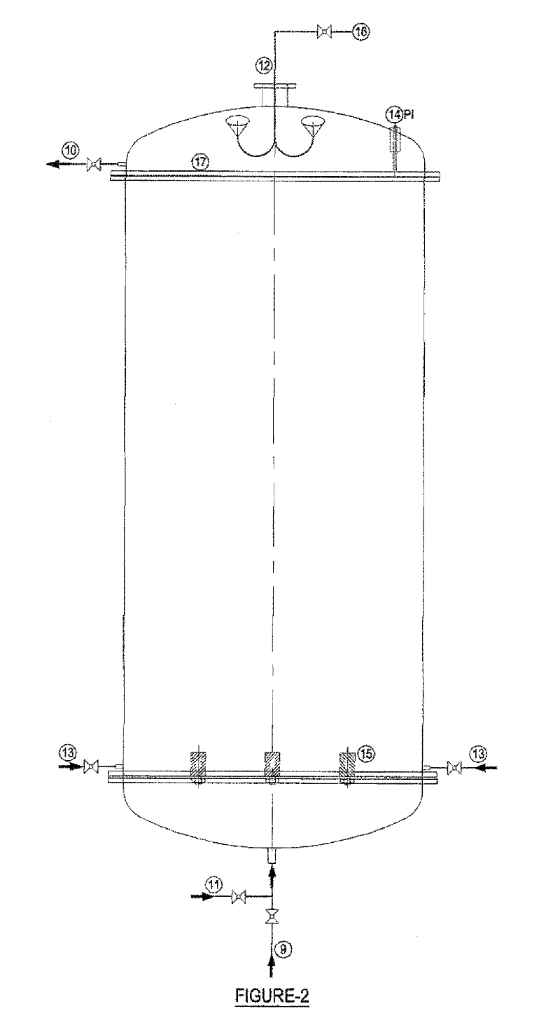

As also illustrated, at least one, three in the example shown, distributors (7) are also provided in the inlet side of the ion exchanger. In the embodiment illustrated in FIG. 1, the distributors have been mounted on the bottom dish plate. However, the distributors may also be mounted on a flange (2) as illustrated in FIG. 2. The distributor has multiple slits in a helical, vertical, or horizontal manner. A preferred distributor or flow modifier having helical slits is illustrated in FIG. 4.

The exchanger is provided with a discharge port (3) on the top dish plate for discharge of solid solution from ion exchanger and a port (5) on the top dish plate that allows exit of air from the ion exchanger. In addition a regeneration port (8) is provided that allows a regenerator to enter and leave the ion exchanger through ports (1) or (4); and recharge the resin bed. Alternatively, the regenerator may also enter the ion exchanger through bottom inlets (1) and (4), and leave the ion exchanger through port (3).

In the embodiment illustrated in FIG. 1, solid solution is passed through the side inlets (6) and compressed air may be passed through any of the bottom inlets (1) or (4). Compressed air if passed enters the ion exchanger through distributors (7) causing the air to swirl. The side inlets (6) serve as flow modifiers and in combination with the compressed air result in the tangential, helical, spiral or agitated flow of the solid solution. It is also possible to pass the solid solution through the distributors (7) and compressed air from the side inlets (6). Alternatively, the solid solution could be passed through the ion exchanger without the use of compressed air, either through side inlets (6) or through distributors (7) in the bottom dish plate. By using, one or more of the flow modifiers the flow of the solid solution is suitably modified as required.

With reference to the embodiment illustrated in FIG. 2, a screen or mesh (17) is provided at the discharge side of the ion exchanger that prevents ionic elements such as resins from leaving the ion exchanger either with the solid solution or with compressed air. Accordingly, the screen is placed before the discharge port (10) for solid solution and discharge port (12) for compressed air. The mesh is so sized that it would retain most of the resin beads within the exchanger. A standard mesh of size 60 to 100 may be used depending on the size and type of resin. As in the earlier embodiment, side inlet means (13) and bottom inlet ports (9) and (11) are provided, which along with distributors (15) work as flow modifiers.

In order to control the discharge of resins from the ion exchanger, a pressure sensor (14) is provided on the screen (17) in accordance with an embodiment of the invention. It is preferable that the pressure on the screen on account of flow of the solid solution through the exchanger is kept to a minimum, and more preferably nil. This assists in controlling the exit of resins from the exchanger. For example, air may be passed through the exchanger at 100 liters/min with the solid solution at a rate of 40 liters/min. Based on the readings of the pressure sensor, the flow rate of the air or solid solution, or both may be altered so as to keep the pressure at the screen to a minimum.

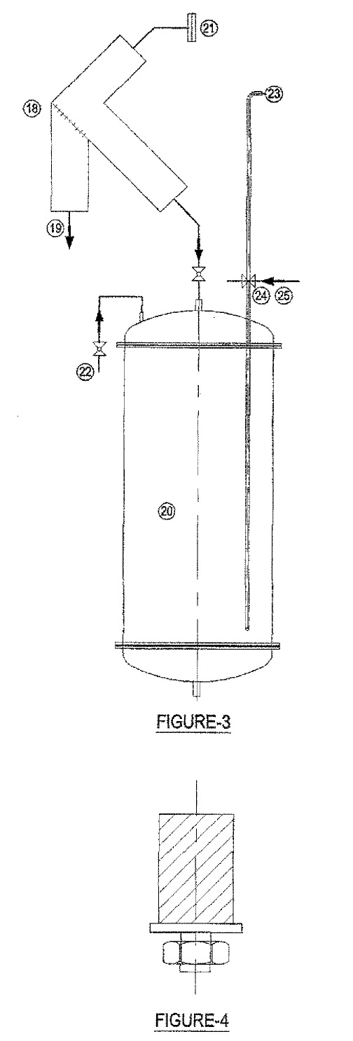

With reference to FIG. 3, a resin recovery system is illustrated in accordance with an embodiment of the invention. The solid solution leaving the exchanger from ports (3, 10) is preferably first sent to a resin recovery system through a port (21). The recovery system includes an inclined screen (18) that prevents resins from flowing out with the solid solution through port (19). The resins so prevented slide down to a tank (20) that serves as a collection tank for resins or the ionic elements discharged. Compressed air is pumped in to the tank (20) through port (22) and sent through outlet (23) back to the ion exchanger. Alternatively, the resins so collected in the tank (20) could be sent back in to the ion exchanger through an ejector (24) with pressurized water inducted from an inlet (25).

In accordance with an embodiment of the invention, the carbon solution discharged from the ion exchanger may be sent to at least one other ion exchanger. Depending on the requirements, a plurality of ion exchangers may be connected in series such that solid solution discharged from one is fed to another so that the solid solution undergoes more than one level of ionic purification for the removal of impurities. The ion exchangers so connected may be cationic, ionic, or mixed bed.

Accordingly, there may be provided a system of removing impurities from solids in which at least two ion exchangers are provided such that the discharge port of one is connected to the inlet port of the other.

In accordance with another embodiment of the invention, the carbon solution recovered from an ion exchanger is fed back into the same ion exchanger for a desired number of cycles, till the required level of purity is achieved. In between two cycles, the carbon solution may be treated in a standby ion exchanger while the ion exchanger is regenerated.

Depending on the purity requirement of the carbon product, the number of recycling or replicate treatment is determined.

An ion exchanger as provided by the invention may be cationic, anionic, or mixed and the types of resins are contingent upon the species and amount of impurities, i.e., cationic resins are used if the impurities are positively charged, and anionic resins for negatively charged ions. The ionic elements used in the ion exchanger may contain resins; or synthetic copolymers of benzene vinyl, styrene, acrylic resin, chloromethyl, and/or ethylene in the form of spherical beads or gel. The ionic elements may also be one of the functional group of sulfonic acid, tri-methyl ammonium, carboxylic acid, and amino.

1. An ion exchanger for removing impurities from solids comprising:
a. an inlet for a solid solution containing impurities, and
b. a flow modifier for modifying the flow of the solid solution within the ion exchanger.

2. An ion exchanger as claimed in claim 1 wherein the ion exchanger is vertically mounted.

3. An ion exchanger as claimed in claim 2 wherein the inlet for solid solution is at the lower end of the ion exchanger.

4. An ion exchanger as claimed in claim 1 comprising an inlet for compressed air.

5. An ion exchanger as claimed in claim 4 wherein the inlet for compressed air is at the lower end of the ion exchanger, and preferably in the lower 10% of the ion exchanger.

6. An ion exchanger as claimed in claim 1 comprising a discharge port for the exit of the solid solution from the ion exchanger.

7. An ion exchanger as claimed in claim 6 wherein the discharge port is at the top end of the ion exchanger, and preferably in the top 10% of the ion exchanger.

8. An ion exchanger as claimed in claim 1 wherein the flow modifier is at least one side inlet.

9. An ion exchanger as claimed in claim 1 wherein the flow modifier is at least one distributor.

10. An ion exchanger as claimed in claim 1 wherein the flow modifier is a combination of at least one side inlet and at least one distributor.

11. An ion exchanger as claimed in claim 1 comprising a regenerator port for introducing a regenerator into the ion exchanger for recharging.

12. An ion exchanger as claimed in claim 1 comprising a screen to prevent exit of ionic elements from ion exchanger.

13. An ion exchanger as claimed in claim 12 comprising a pressure sensor for measuring the pressure on the screen.

14. A system of ion exchangers comprising at least two ion exchangers wherein each ion exchanger comprises:
a. an inlet port for a solid solution containing impurities, and
b. a flow modifier for modifying the flow of the solid solution within the ion exchanger;
and discharge port of at least one ion exchanger is connected to the inlet of at least one other ion exchanger.

15.-16. (canceled)
